(19) United States
(12) Patent Application Publication
(10) Pub. No.: US 2010/0192053 A1
(43) Pub. Date: Jul. 29, 2010

(54) WORKFLOW SYSTEM AND METHOD OF DESIGNING ENTRY FORM USED FOR WORKFLOW

(75) Inventor: Akihiko Fujiwara, Yokohama-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/690,585

(22) Filed: Jan. 20, 2010

Related U.S. Application Data
(60) Provisional application No. 61/147,288, filed on Jan. 26, 2009.
(60) Provisional application No. 61/147,290, filed on Jan. 26, 2009.

(51) Int. Cl. G06F 17/00

(52) U.S. Cl. 715/222

(57) ABSTRACT

A workflow system stores types of input information input which are input to activities that are constitution units of a workflow in an activity input information type storage module, stores types of output information which are output from the activities in an activity output information type storage module, determines input information needed for a workflow constituted by a plurality of the activities depending on the types of the input and output information of the activities stored in the activity input information type storage module and the activity output information type storage module, and provides a design environment for designing an input form to input the determined input information needed for the workflow, thereby creating the input form designed in the design environment.

### CROSS-REFERENCE TO RELATED APPLICATION

This application claims the benefit of U.S. Provisional Applications No. 61/147,288, filed Jan. 26, 2009; and No. 61/147,290, filed Jan. 26, 2009.

### TECHNICAL FIELD

The present invention relates to a workflow system for executing processes of a workflow by acquiring input information filled in an entry form and using the acquired input information by an image processing apparatus such as a digital multi-function peripheral (MFP).

### BACKGROUND

In the past, there is a workflow system implemented by a digital multi-function peripheral, an external server, and the like. In the workflow system, the digital multi-function peripheral and the external server execute and manage a workflow process. The workflow system scans, for example, a paper document completed with information by a user, analyzes the scanned (computerized into electronic data) document image (by OCR of the like), and transmits the image to an appropriate destination. For example, US Unexamined Patent Application Publication No. 2008/0154685 discloses a technique of a workflow system.

In addition, in the existing workflow system, the digital multi-function peripheral prints a paper document for inputting information by the user. The digital multi-function peripheral creates the paper document by printing an entry form in which input fields for inputting information are arranged onto a sheet. In the workflow system, in order to properly perform a process using the paper document, entry layouts for forms capable of enhancing convenience of the user need to be designed.

There may be a case where various types of paper document for inputting information by the user are needed depending on types of workflow in the workflow system. Designing different entry layouts for forms depending on the types of workflow is a large burden to a designer. Accordingly, it is not easy to design in advance a paper document for the inputting of information by a user.

### SUMMARY

According to an aspect of the invention, a workflow system comprises: an activity storage module configured to store activities which are process constitution units of a workflow; an input type storage module configured to store types of input information which are input to the activities stored in the activity storage module; an output type storage module configured to store types of output information which are output from the activities stored in the activity storage module; an information determination module configured to determine input information needed for the workflow constituted by a plurality of the activities depending on the types of the input information and the output information of the activities stored in the input type storage module and the output type storage module; a form creation module configured to create an input form for inputting the input information determined by the information determination module; and a form design operation module configured to provide an environment for designing the input form created by the form creation module.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically illustrating a configuration of an image processing system applying a workflow system.

FIG. 2 is a diagram illustrating a configuration example of a workflow system according to a first embodiment.

FIG. 3 is a diagram illustrating a configuration example of a table showing a correspondence between existing workflows and information types.

FIG. 4 is a diagram illustrating a design example of an entry form.

FIG. 5 is a flowchart for explaining a design procedure of the entry form.

FIG. 6 is a diagram illustrating a configuration example of a workflow system according to a second embodiment.

FIG. 7 is a flowchart for explaining a design procedure of an entry form used in a workflow including an external sub-workflow.

FIG. 8 is a diagram illustrating a configuration example of a workflow system according to a third embodiment.

FIG. 9 is a diagram illustrating a configuration example of a workflow system according to a fourth embodiment.

FIG. 10 is a diagram illustrating a configuration example of a workflow system according to a fifth embodiment.

FIG. 11 is a diagram illustrating a configuration example of a workflow system according to a sixth embodiment.

FIG. 12 is a diagram illustrating an example of an entry form assigned with code information generated by a code generating module.

### DETAILED DESCRIPTION

Exemplary embodiments of the invention will be described with reference to the accompanying drawings.

A workflow system according to an embodiment executes a series of processes (jobs) for a particular purpose as a workflow. The workflow system is represented by an image processing system including a single or a plurality of servers connected to a digital multi-function peripheral (MFP). The workflow system is a system for executing a series of processes including document processing using the digital multi-function peripheral and the server.

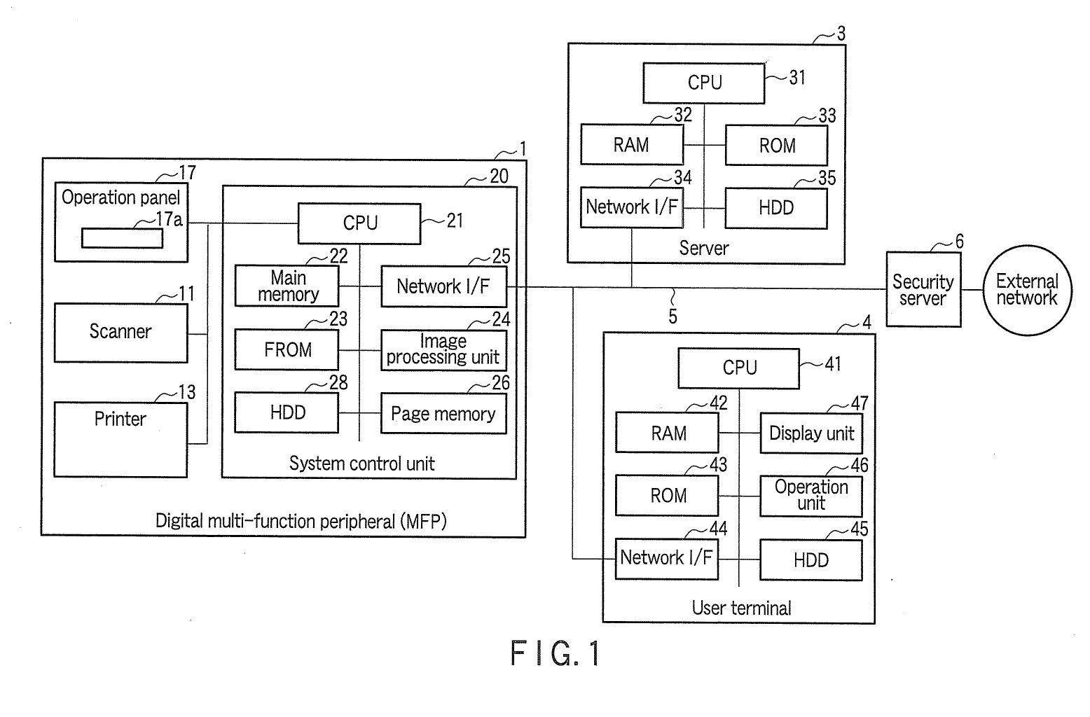

FIG. 1 is a diagram schematically illustrating a configuration of an image processing system applying a workflow system.

As illustrated in FIG. 1, the image processing system applying the workflow system includes a digital multi-function peripheral 1, a server 3, a user terminal 4, and a local area network 5. The local area network 5 is connected to an external network via a security server 6. The security server 6 is a server for connecting to the external network from the local area network 5 and has a function of controlling access to the local area network 5 from the outside. In addition, a plurality of the servers 3 or a plurality of the user terminals 4 may be connected to the local area network 5.

The digital multi-function peripheral (MFP) 1 functions as an image forming apparatus or an image reading apparatus. The digital multi-function peripheral 1 has a scanner function, a printer function, a network communication function, a facsimile function, and the like. The server 3 is a server computer. The digital multi-function peripheral 1 and the server 3 each have various processing functions implemented by executing application programs stored in a memory by a control unit (CPU). The user terminal 4 is a terminal device used by a user. The server 3 and the user terminal 4 each have a function of data communication with the digital multi-function peripheral 1 via the local area network 5.

The digital multi-function peripheral 1 includes a scanner (image reading unit) 11, a printer (image forming unit) 13, an operation panel 17, and a system control unit 20. In addition, the digital multi-function peripheral 1 may includes a facsimile interface or the like for transmitting and receiving facsimile data.

The scanner 11 reads an image on a document surface by optically scanning the document surface. The scanner 11 converts the image on the document surface into color image data (multi-valued image data) or monochrome image data. The scanner 11 includes a scanning mechanism, a photoelectric conversion unit, and an automatic document feeder (ADF).

The printer 13 is a unit for forming the image based on the color image data (multi-valued image data) or the monochrome image data onto a sheet. The printer 13 is not limited to a particular image forming method. For example, the printer 13 may be an image forming apparatus using electrophotography, an ink jet type, a heat transfer type, or the like.

The operation panel 17 is a user interface. The operation panel 17 includes various operation keys and a display unit (display unit) 17a having a touch panel. The operation panel 17 functions as an operation unit for inputting an operation instruction of a user and a display unit for displaying a guide for the user.

The system control unit 20 entirely controls units in the digital multi-function peripheral 1. For example, the system control unit 20 controls the scanner 11 and the printer 13. The system control unit 20 acquires an instruction of the user from the operation panel 17. The system control unit 20 includes a CPU 21, a main memory 22, an FROM 23, an image processing unit 24, a network interface 25, a page memory 26, and an HDD 28.

The CPU 21 is a control unit which controls the digital multi-function peripheral 1. The CPU 21 implements various processing functions by executing control programs stored in the FROM 23 or the HDD 28. The main memory 22 is configured as a random access memory (RAM). The main memory 22 functions as a working memory. The FROM 23 is configured as a re-writable non-volatile memory. The FROM 23 stores control programs, control data, and the like, which control operations of the digital multi-function peripheral 1. Furthermore, the control data, setting information, and the like are written in the FROM 23. The FROM 23 may store various flags representing various operation statuses.

The image processing unit 24 performs image processing on image data read by the scanner 11 or image data received from the user terminal 3 via the network. The network interface 25 is a LAN interface for communication with an external apparatus via the local area network 5. The page memory 26 is a memory for deploying image data for printing. The page memory 26 can secure a region for deploying at least one page of image data. The HDD 28 is a large-capacity memory for data storage. The HDD 28 accumulates, for example, image data to be printed.

A configuration of the server 3 will now be described.

The server 3 includes a CPU 31, a RAM 32, a ROM 33, a network interface (I/F) 34, and a HDD 35.

The CPU 31 is a control unit which controls the entire server 3. The CPU 31 implements various processing functions on the basis of control programs stored in the ROM 33 and the HDD 35. The RAM 32 is a working memory. The ROM 33 stores control programs, control data, and the like which control basic operations of the server 3. The HDD 35 is a storage device for data storage. The network interface 34 is an LAN interface for data communication with each device in the local area network 5. For example, the server 3 can transmit and receive data to and from the digital multi-function peripheral 1 via the local area network 5 by the network interface 34.

The user terminal 4 includes a CPU 41, a RAM 42, a ROM 43, a network interface (I/F) 44, an HDD 45, a display unit 46, and an operation unit 47.

The CPU 41 implements various processing functions on the basis of control programs stored in the ROM 43 and the HDD 45. The RAM 42 is a working memory. The ROM 43 stores control programs, control data, and the like which control basic operations of the user terminal 4. The HDD 45 is a storage device for data storage. The network interface 44 is a LAN interface for data communication with each device in the local area network 5. For example, the user terminal 4 can transmit and receive data to and from the digital multi-function peripheral 1 via the local area network 5 by the network interface 44.

Hereinafter, workflow systems according to first to sixth embodiments implemented by the image processing system as described above will be described.

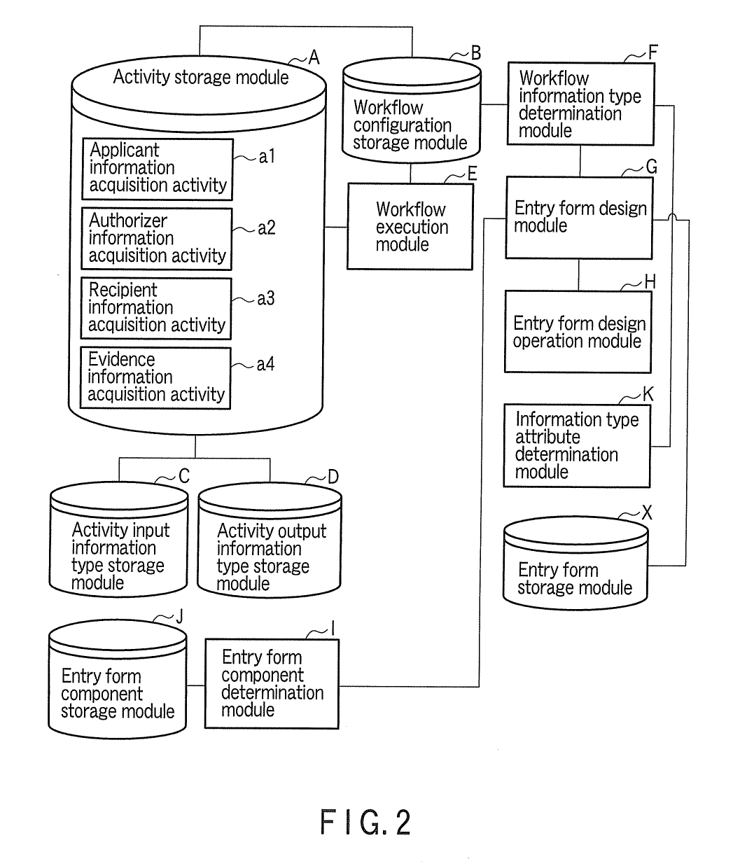

In addition, the workflow system according to each embodiment described later is configured by a plurality of modules as illustrated in FIGS. 2, 6, 8, 9, 10, and 11. The modules are disposed in, for example, the server 3. Some or all of the modules may be disposed in the digital multi-function peripheral 1. Otherwise, the modules may be disposed in, for example, the plurality of servers 3. Some of the modules may be disposed in a server on an external network (for example, a network outside a company such as Internet other than a LAN in the company provided with the digital multi-function peripheral 1). That is, the workflow system implements a workflow that is a series of processes by the modules disposed in the digital multi-function peripheral 1, the single or the plurality of the servers 3, or the server on the external network.

Each storage module is configured as a memory. The storage module in each embodiment is implemented by, for example, the memory (for example, the HDD 35) in the server 3 and the memory (for example, the HDD 28) in the digital multi-function peripheral 1. Modules (control modules) other than the storage module are functions implemented by the programs by the control unit. In each embodiment, each control module is implemented by executing programs by the CPU 31 in the server 3 or the CPU 21 in the digital multi-function peripheral 1.

The programs for implementing the control modules are stored by the memories that can be read by the CPU 31 of the server 3 or the CPU 21 of the digital multi-function peripheral 1. The programs for implementing the control modules may be stored in computer-readable storage media, and may be installed on the system control unit 20 of the digital multi-function peripheral 1 or the server 3 via the storage media.

First, the first embodiment will be described.

FIG. 2 is a diagram illustrating a configuration example of a workflow system according to the first embodiment.

As illustrated in FIG. 2, the workflow system according to the first embodiment includes an activity storage module A, a workflow configuration storage module B, an activity input information type storage module (input type storage module) C, an activity output information type storage module (output type storage module) D, a workflow execution module E, a workflow information type determination module (information determination module) F, an entry form design module (form creation module) G, an entry form design operation module (form design operation module) H, an entry form component determination module (component determination module) I, an entry form component storage module (component storage module) J, an information type attribute determination module (attribute determination module) K, and an entry form storage module X.

The activity storage module A stores various activities which are process constitution units of a workflow. An activity is a program (a set of software) for implementing various processes which can be a part of the workflow. The workflow is configured by combining a plurality of activities stored in the activity storage module A. That is, the workflow is executed by combining and executing the plurality of activities.

In the configuration example illustrated in FIG. 2, the activity storage modules A stores an applicant information acquisition activity a1, an authorizer information acquisition activity a2, a recipient information acquisition activity a3, and an evidence information acquisition activity a4.

The applicant information acquisition activity a1 receives information for specifying a user who is an applicant of a workflow (for example, “applicant name” or “applicant affiliation”) as an input, specifies the user who is the applicant from the information using a directory service or the like and then converts the specified user into information (for example, “employee ID number” that can be uniquely assigned to the user) that can be distributed through the workflow, and outputs the information as “applicant information”.

The authorizer information acquisition activity a2 receives information for specifying a user who is an authorizer of the workflow (for example, “applicant name” and “applicant affiliation”) as an input, specifies the user who is the authorizer from the information using a directory service or the like and then converts the specified user into information (for example, “employee ID number” that can be uniquely assigned to the user) that can be distributed through the workflow, and outputs the information as “authorizer information”.

The recipient information acquisition activity a3 receives information for specifying a recipient (for example, “financial institution name”, “branch ID”, “account ID”, and “account holder”) as an input, specifies the recipient from the information and then converts the specified recipient into information (for example, “recipient number” that is uniquely assigned and managed by Client Master data) that can be distributed through the workflow, and outputs the information as “recipient information”. In addition, the account name may be omitted if it is the same as the applicant name.

The evidence information acquisition activity a4 receives information for confirming evidence such as a receipt (for example, “receipt image” computerized into electronic data by a scanner) as an input and outputs the information as “evidence information”.

The workflow configuration storage module B stores information on the workflow configured by the activities stored in the activity storage module A. The workflow configuration storage module B stores information for specifying each activity configuring the workflow, information on an execution procedure of the activities, information on a workflow name, and the like.

The activity input information type storage module C stores information on an information type input to each activity. For example, the activity input information type storage module C stores information representing that the input information of the applicant information acquisition activity a1 is information for specifying the user who is the applicant of the workflow (for example, “applicant name” or “applicant affiliation”).

The activity output information type storage module D stores information on an information type output from each activity. For example, the activity output information type storage module D stores information representing that the output information of the applicant information acquisition activity a1 is applicant user information (for example, “employee ID number” that can be uniquely assigned to the user) which is information that can be distributed through the workflow.

The workflow execution module E executes the workflow by executing the activities in the order depending on the information representing the configuration of the workflow stored in the workflow configuration storage module B. For example, the workflow execution module E executes a series of processes (workflow) by acquiring the input information from the entry form completed with the input information by the user.

The workflow information type determination module F determines which type of information is input to or output from each activity configuring the workflow. For example, the workflow information type determination module F specifies one activity in the workflow stored in the workflow configuration storage module B. The workflow information type determination module F determines which type of information is input to or output from the specified activity.

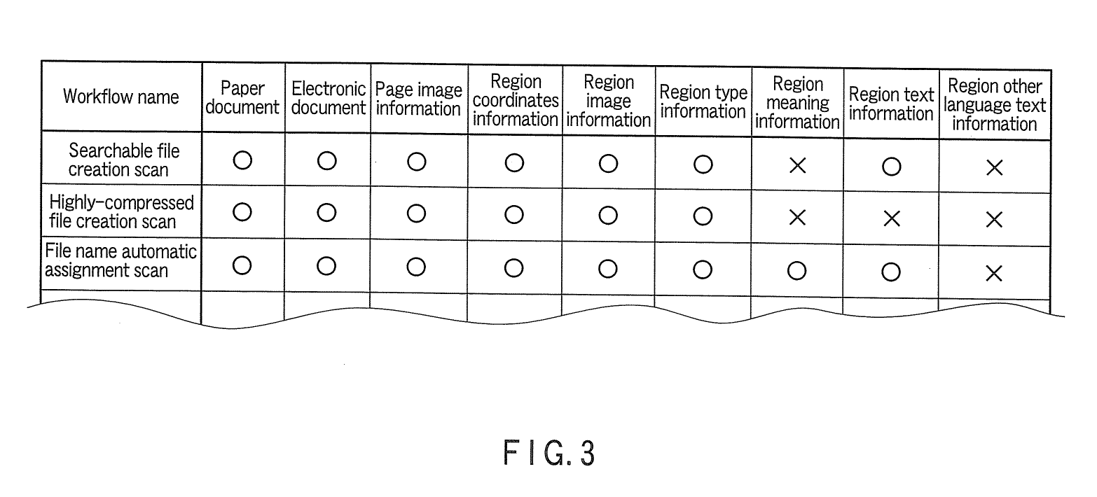

Furthermore, the workflow information type determination module F may manage types of input and output data for each activity configuring an existing workflow. For example, FIG. 3 is a diagram illustrating a configuration example of a table showing a correspondence between existing workflows and information types. The example illustrated in FIG. 3 represents whether or not existing various workflows correspond to paper documents, electronic documents, page image information, region coordinates information, region image information, region type information, region meaning information, region text information, and region other language text information.

The entry form design module G designs an entry form to be completed by the user with input information needed for executing the workflow, which is determined by the workflow information type determination module F. For example, the entry form design module G designs an entry form to provide a layout of fields for entering an “applicant name” and an “applicant affiliation” as input information in the case of the workflow using the applicant information acquisition activity a1.

The entry form design operation module H provides an environment for the design of the entry form, which is executed by the entry form design module G, for the user. For example, the entry form design operation module H is an application having a GUI and provides a design environment of the entry form for the user. For example, the entry form design operation module H provides a design environment for displaying components such as input fields to be arranged in the entry form and a preview of the entry form to be printed onto a sheet during the designing. In such a design operation, the user can simply perform the design operation.

The entry form component determination module I determines components configuring the entry form designed by the entry form design module G. For example, the entry form component determination module I determines that if input fields for entering an “applicant name” and an “applicant affiliation” as input information of the applicant information acquisition activity a1 are needed, box components for entering text are needed as the input fields of the “applicant name” and the “applicant affiliation”.

The entry form component storage module J stores components of the entry form selected by the entry form component determination module I. For example, the entry form component storage module J stores a rectangular component or the like having ruled lines formed to enter text letter by letter as the box component for entering the text.

The information type attribute determination module K determines attributes for each piece of information needed for executing the workflow, which is determined by the workflow information type determination module F. For example, the information type attribute determination module K determines “applicant name” as an attribute that represents an essential attribute and determines “applicant affiliation” as an optional attribute that represents optional information, between “applicant name” and “applicant affiliation” which is the input information of the applicant information acquisition activity a1. In addition, the entry form storage module X stores the entry form designed by the entry form design module G.

A design example of the entry form used for the workflow will now be described.

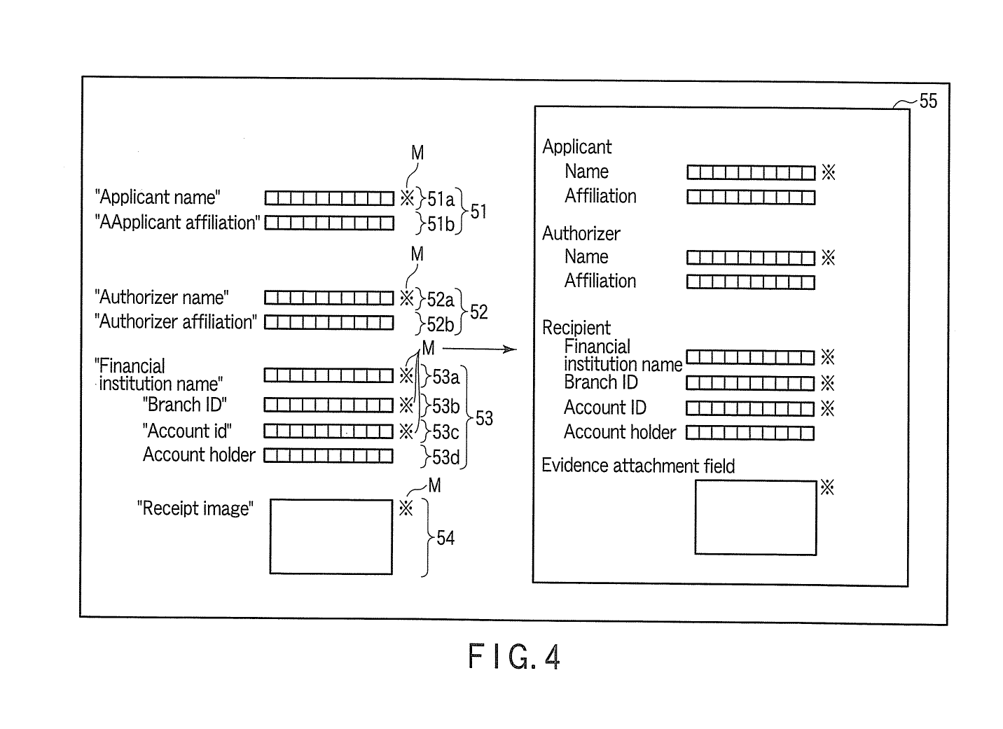

FIG. 4 is a diagram illustrating a design example of an entry form. FIG. 4 illustrates the design example of the entry form used for the workflow for a travel expense application with evidence attached (receipt image). The workflow for a travel expense application with evidence attached (receipt image) as illustrated in FIG. 4 includes, as activities for processing the input information, the applicant information acquisition activity a1, the authorizer information acquisition activity a2, the recipient information acquisition activity a3, and the evidence information acquisition activity a4.

In the applicant information acquisition activity a1, an applicant name and an applicant affiliation are input information. Accordingly, it is determined that a component 51 including input fields (text boxes) 51a and 51b for inputting the applicant name and the applicant affiliation is needed as a form component for acquiring applicant information for an entry form.

In the authorizer information acquisition activity a2, an authorizer name and an authorizer affiliation are input information. Accordingly, it is determined that a component 52 including input fields (text boxes) 52a and 52b for inputting the authorizer name and the authorizer affiliation is needed as a form component for acquiring authorizer information for the entry form.

In the recipient information acquisition activity a3, a financial institution name representing a recipient, a branch number (branch ID), an account number (account ID), and an account holder are input information. Accordingly, it is determined that a component 53 including input fields (text boxes) 53a, 53b, 53c, 53d for inputting the financial institution name, the branch number (branch ID), the account number (account ID), and the account holder is needed as a form component for acquiring recipient information for the entry form.

In the evidence information acquisition activity a4, an image of a receipt is input information. Accordingly, it is determined that a component 54 including an attachment field for attaching the image of the receipt is needed as a form component for acquiring evidence information for the entry form.

The entry form design module G determines the components 51 to 54 (the input fields of the input information) needed for the entry form depending on the activities selected by the entry form component determination module I on the basis of the specification of the workflow. If the components needed for the entry form are determined, the entry form design operation module H provides an environment for the user to arrange the components 51 to 54 so as to set the layout of the entry form 55.

For example, the entry form design operation module H displays, as illustrated in FIG. 4, the components corresponding to the input information and a frame of the entry form in which the layout of the components is set on the display unit 46 of the user terminal 4. The designer sets the layout of the components by dragging the components 51 to 54 displayed on the display unit 46 of the user terminal 4 and dropping them into the frame of the entry form 55. In addition, the entry form design module G or the entry form design operation module H may automatically generate an entry form in which a layout of components needed for input information is set to allow the designer to change the layout of the components for the generated entry form.

Furthermore, the entry form component determination module I may extract a plurality of component candidates for one piece of input information from the entry form component storage module J. For example, if the input information is text information, the entry form component determination module I extracts “underline-attached entry area”, “free description rectangle box”, “format description ruled line-attached rectangle box”, and the like as component candidates. If a plurality of component candidates is extracted for each piece of input information, the entry form design operation module H may display a list of the plurality of component candidates for each piece of input information to allow the user to select components to be employed by the entry form from the displayed component candidates.

The entry form component determination module I may select an input field assigned with information representing an attribute of input information as a component. For example, the information type attribute determination module K may determine an attribute representing whether or not input information is essential or optional information. In this case, an input field representing essential input information is selected as a component for essential input information. For example, in the example illustrated in FIG. 4, an input field of input information that is determined to be essential is assigned with a mark M.

An example of a procedure of setting an entry form in the workflow system will now be described.

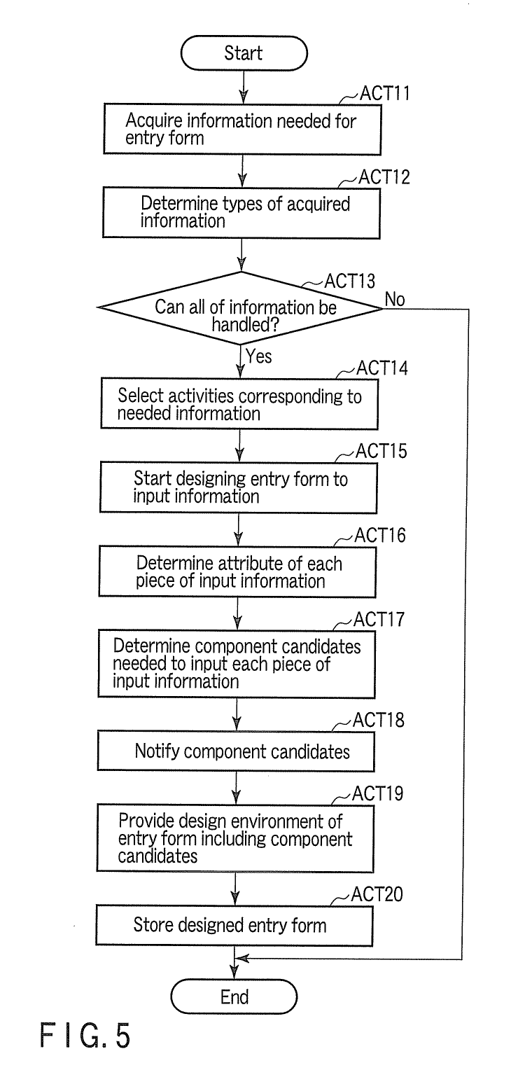

FIG. 5 is a flowchart for explaining a design procedure of the entry form. Here, as a specific example, a procedure of designing the entry form used for the “workflow for a travel expense application with evidence attached (receipt image)” as illustrated in FIG. 4 is considered.

First, the designer analyzes which information is needed for an entry form used for the workflow depending on the specification of the workflow. The designer designates information needed for the entry form as an analysis result using the user terminal 4. For example, if the entry form used for the “workflow for a travel expense application with evidence attached (receipt image)” is to be designed, the designer analyzes information needed for the entry form for the travel expense application depending on the specification of the travel expense application. The travel expense application needs information for specifying an applicant (applicant information), information for specifying an authorizer (authorizer information), information indicating a recipient of the travel expense (recipient information), and information representing evidence such as a receipt (evidence information).

The information needed for the entry form used by the workflow is acquired (Act 11). The workflow information type determination module F determines a type of the information needed for the entry form used by the workflow (Act 12). The workflow information type determination module F determines a type of each piece of the information needed for the entry form by referring to the type of the input information managed by the activity input information type storage module C and the type of the output information managed by the activity output information type storage module D. In addition, the workflow information type determination module F determines whether or not all of the information needed for the entry form is information that can be handled by the workflow system (Act 13).

If it is confirmed that all of the information needed for the entry form is the information that can be handled by the workflow system (Yes in Act 13), an activity corresponding to the information needed for the entry form is selected (Act 14). The activity input information type storage module C manages types of input information to be matched with the corresponding activities stored in the activity storage module A. Accordingly, the activities matched with the corresponding types of the information needed for the entry form are selected on the basis of the information managed by the activity input information type storage module C. For example, in the “workflow for a travel expanse application with evidence attached”, the applicant information acquisition activity a1 for acquitting applicant information, the authorizer information acquisition activity a2 for acquiring authorizer information, the recipient information acquisition activity a3 for acquiring recipient information, and the evidence information acquisition activity a4 for acquiring evidence information are selected.

The applicant information acquisition activity a1 outputs applicant information that can uniquely specify the user who is an applicant as input information which is “applicant name” and “applicant affiliation”. For example, the applicant information acquisition activity a1 converts the input information into the applicant information using a directory service or the like. For example, if “employee ID number” can be distributed as information that can uniquely specify the user in the workflow system, the applicant information acquisition activity a1 outputs “employee ID number” as the applicant information using “applicant name” and “applicant affiliation” as the input information.

The authorizer information acquisition activity a2 outputs authorizer information that can be distributed in the workflow system by using “authorizer name” and “authorizer affiliation” as input information similar to the applicant information acquisition activity a1.

The recipient information acquisition activity a3 outputs recipient information that uniquely specifies a recipient by using “financial institution name”, “branch ID”, “account ID”, and “account holder” as input information. For example, the recipient information acquisition activity a3 converts the input information into the recipient information by referring to the Client Master data (not shown). If “recipient number” can be distributed as information that can uniquely specify a recipient in the workflow system, the recipient information acquisition activity a3 outputs “recipient number” as the recipient information using the “financial institution name”, “branch ID”, “account ID”, and “account holder” as the input information.

The evidence information acquisition activity a4 outputs evidence information for confirming evidence using an image of a receipt (evidence) as input information. The image of the receipt is, for example, image information computerized into electronic data from the image of the receipt by the scanner of the digital multi-function peripheral 1. The evidence information acquisition activity a4 outputs the image information computerized into electronic data from the image of the receipt as the “evidence information”.

If the activities constituting the workflow are selected, the entry form design module G designs an entry form to be completed with the input information of the selected activities by the user (Act 15). The input information in the entire workflow is determined by the workflow information type determination module F. That is, if the workflow information type determination module F determines the input information needed for the workflow, the entry form design module G designs the entry form to be completed by the user with the input information determined by the workflow information type determination module F.

In addition, if the entry form is designed, the information type attribute determination module K may determine an attribute of each piece of the input information determined by the workflow information type determination module F. For example, the information type attribute determination module K determines an attribute that represents whether each piece of information determined as the input information by the workflow information type determination module F is essential information or optional information (Act 16).

The entry form component determination module I determines component candidates to be used as input fields (components of the entry form) corresponding to the pieces of the input information (Act 17). For example, the input information of the applicant information acquisition activity a1 is “applicant name” and “applicant affiliation”. Both “applicant name” and “applicant affiliation” are “text information”. Accordingly, the entry form component determination module I determines that components for entering an “applicant name” and an “applicant affiliation” as “text information” are needed.

Components needed for designing the entry form are stored in the entry form component storage module J. For example, the entry form component storage module J stores “underline-attached entry area”, “free description rectangle box”, “format description ruled line-attached rectangle box”, and the like as the components of the entry form for entering “text information”.

The entry form component determination module I determines component candidates as input fields suitable for the input information from the entry form component storage module J. In addition, the entry form component determination module I may determine component candidates representing the attributes of the input information determined by the information type attribute determination module K. In this case, the entry form component determination module I determines component candidates that may identify input information that is determined as essential information and input information that is determined as optional information by the information type attribute determination module K. In the example illustrated in FIG. 4, as the input field of essential input information, components assigned with a mark M are candidates, and as the input field of optional input information, components that are not assigned with a mark are candidates.

If the component candidates corresponding to the input information needed for the workflow are determined, the entry form component determination module I notifies the entry form design module G of the component candidates determined by the entry form component storage module J (Act 18). The entry form design module G sends the component candidates for the input information supplied from the entry form component determination module I to the entry form design operation module H.

The entry form design operation module H provides an environment for designing the entry form used for the workflow to the designer by using the information (the component candidates corresponding to the input information) assigned by the entry form design module G (Act 19). The entry form design operation module H provides an application having a GUI as the design environment used for designing the entry form by the designer. For example, the entry form design operation module H provides an application that may arrange components selected from a candidate component list acquired by the entry form design module G in the entry form by an operation of the user terminal 4.

In the design environment of the entry form provided by the entry form design operation module H, the designer can select desired components from the component candidate list or dispose the selected components at positions intended by the designer. In addition, the entry form design operation module H may provide an entry form in which components that are automatically determined to be the most appropriate (or components set as the default) are disposed in the order and allow the designer to confirm and adjust the provided entry form.

If the entry form is designed in the design environment of entry form provided by the entry form design operation module H, the entry form design module G stores the designed entry form in the entry form storage module X (Act 20). The entry form stored in the entry form storage module X is appropriately read by an operation of the user who executes the workflow and printed onto a sheet.

In the workflow system according to the first embodiment as described above, it is possible to simply design an entry form used for a workflow for the workflow that can be freely configured by combining a plurality of activities. In addition, in the workflow system according to the first embodiment, input fields for inputting input information needed for the workflow are provided as component candidates, so that the entry form can be simply designed. Furthermore, in the workflow system according to the first embodiment, since the function of determining an attribute of each piece of input information is provided, it is possible to represent the attribute of each piece of input information for the component candidates arranged in the entry form.

A second embodiment will now be described.

A part of or the entire workflow can be executed by an external system connected via a network. For example, recently, similar to SOA or SaaS, an environment is provided where a part of or the entire workflow is executed by an external system which is connected via a network. Executing a part of workflow using an external system is referred to as an external sub-workflow. In a second embodiment, a workflow system having the function of designing an entry form used for a workflow including an external sub-workflow will be described.

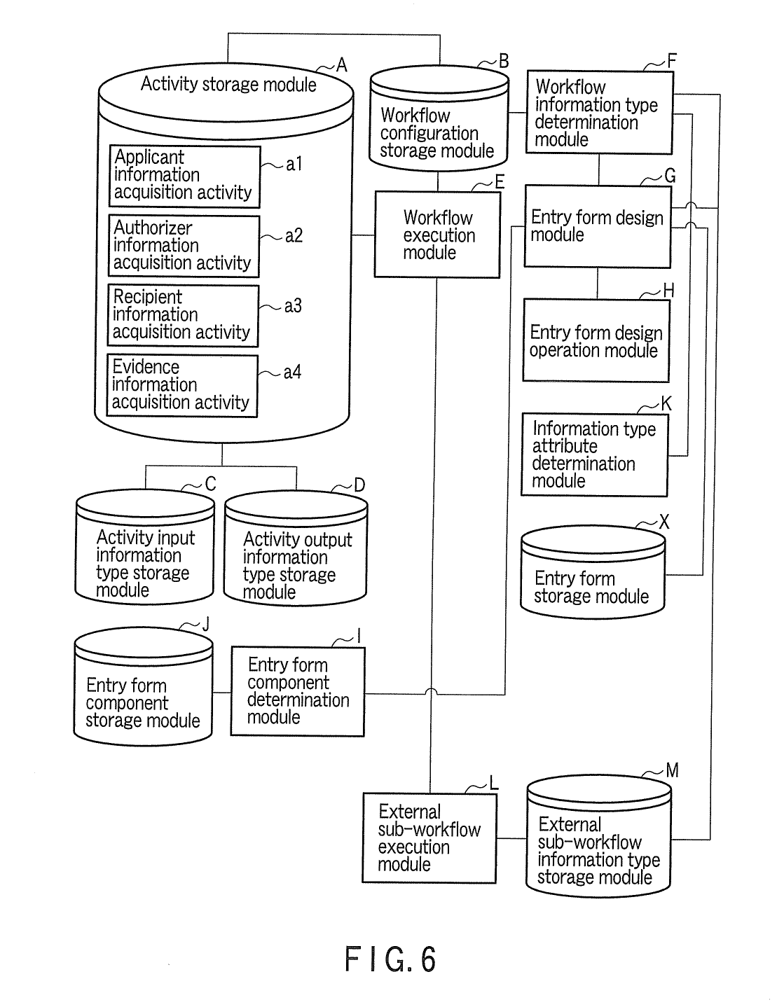

FIG. 6 is a diagram illustrating a configuration example of the workflow system according to the second embodiment.

As illustrated in FIG. 6, the workflow system according to the second embodiment includes an activity storage module A, a workflow configuration storage module B, an activity input information type storage module C, an activity output information type storage module D, a workflow execution module E, a workflow information type determination module F, an entry form design module G, an entry form design operation module H, an entry form component determination module I, an entry form component storage module J, an information type attribute determination module K, an external sub-workflow execution module L, and an external sub-workflow information type storage module (external type storage module) M.

The activity storage module A, the workflow configuration storage module B, the activity input information type storage module C, the activity output information type storage module D, the workflow execution module E, the workflow information type determination module F, the entry form design module G, the entry form design operation module H, the entry form component determination module I, the entry form component storage module J, and the information type attribute determination module K may be implemented as the same modules described in the first embodiment.

The external sub-workflow execution module L executes an external sub-workflow in an external system. The external sub-workflow execution module L executes activities that are not stored in the activity storage module A of the workflow in connection with the external system. Processes of the external sub-workflow are executed by the external system in a network environment provided by, for example, SOA, ASP, or SaaS.

The external sub-workflow execution module L implements the external sub-workflow using an external sub-workflow connector activity a5 stored in the activity storage module A. The external sub-workflow connector activity a5 connects to the external system that executes the external sub-workflow as a part of the workflow. That is, the external sub-workflow connector activity a5 is an activity for switching the part of the workflow to be executed by the external system.

The external sub-workflow information type storage module M manages information types used by the external sub-workflow executed by the external sub-workflow execution module L. For example, as the external sub-workflow, a settlement service including checking of recipient information is considered. If the settlement service is used as the external sub-workflow in the workflow, the external sub-workflow information type storage module M stores “financial institution name”, “branch ID”, and “account ID” as input information needed for an external sub-workflow of the settlement service. That is, the input information needed for the external sub-workflow can be determined by the external sub-workflow information type storage module M.

Design of an entry form using a workflow including an external sub-workflow will now be described.

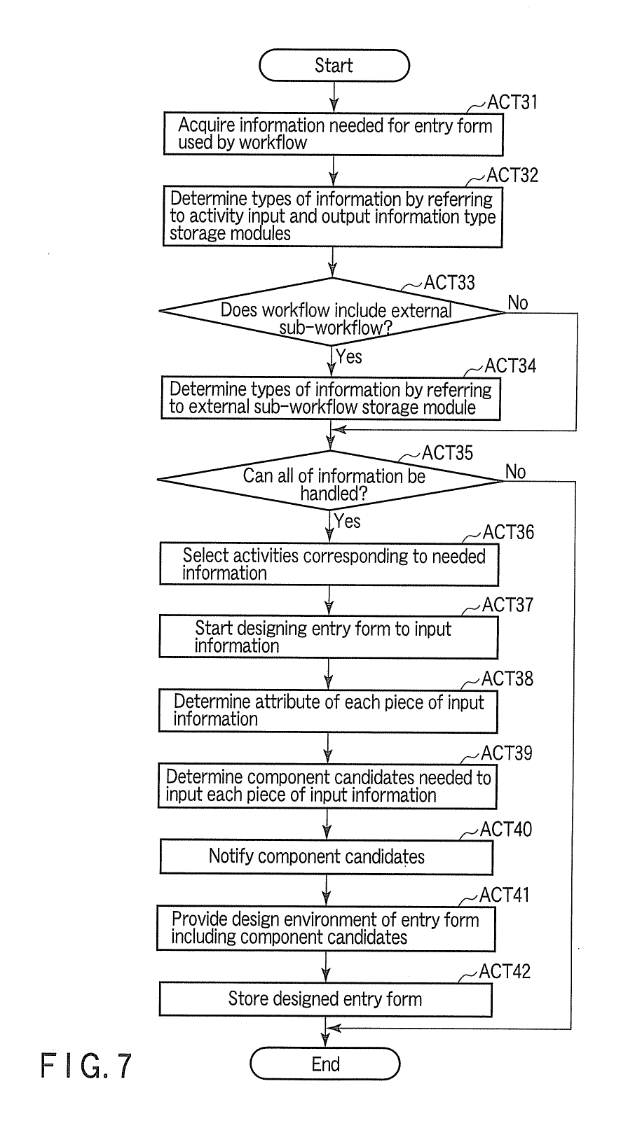

FIG. 7 is a flowchart for explaining a design procedure of an entry form used in a workflow including an external sub-workflow. In addition, processes of Act 31 and 32 and Acts 35 to 42 can be implemented by substantially the same processes as the processes of Acts 11 to 20 illustrated in FIG. 5 described according to the first embodiment. Accordingly, detailed description of the processes of the Acts 31 to 32 and Acts 35 to 42 will be omitted.

That is, the workflow information type determination module F determines the information types of the input and output information of the activities stored in the activity storage module A from among the activities constituting the workflow by referring to the activity input information type storage module C and the activity output information type storage module D.

Information needed for the external sub-workflow is stored in the external sub-workflow information type storage module M. Accordingly, if the workflow includes the external sub-workflow (Yes in Act 33), the workflow information type determination module F determines the information types needed for the external sub-workflow by referring to the external sub-workflow information type storage module M (Act 34). The information stored in the external sub-workflow information type storage module M is set in advance as an interface specification of the external sub-workflow. For example, the information stored in the external sub-workflow information type storage module M is described by WSDL which is an external specification description of a Web service or the like.

Furthermore, the workflow information type determination module F determines the information types of the input information in the workflow other than the external sub-workflow as described above according to the first embodiment. That is, all pieces of the input information of the entire workflow including the external sub-workflow are determined by the workflow information type determination module F. In general, if all pieces of the input information of the entire workflow including the external sub-workflow are information that can be used by the workflow system (Yes in Act 35), the entry form design module G designs an entry form to be completed with each piece of information determined as the input information by the workflow information type determination module F by the user (Acts 36 to 42).

In Act 39, components of the entry form for the input information of the external sub-workflow are determined on the basis of the information types of the input information obtained from the external sub-workflow information type storage module M. For example, the components of the entry form for the input information of the external sub-workflow may be defined along with the information types by the external sub-workflow information type storage module M. In addition, the entry form component determination module I may be allowed to determine components that can be used from the entry form component storage module J by recognizing a data format (“text information” or the like) of an information type as a general data type of information.

In the workflow system according to the second embodiment as described above, since component candidates for the input information can be provided by determining the input information needed for the workflow including the external sub-workflow, it is possible to simply design the entry form used by the workflow.

A third embodiment will now be described.

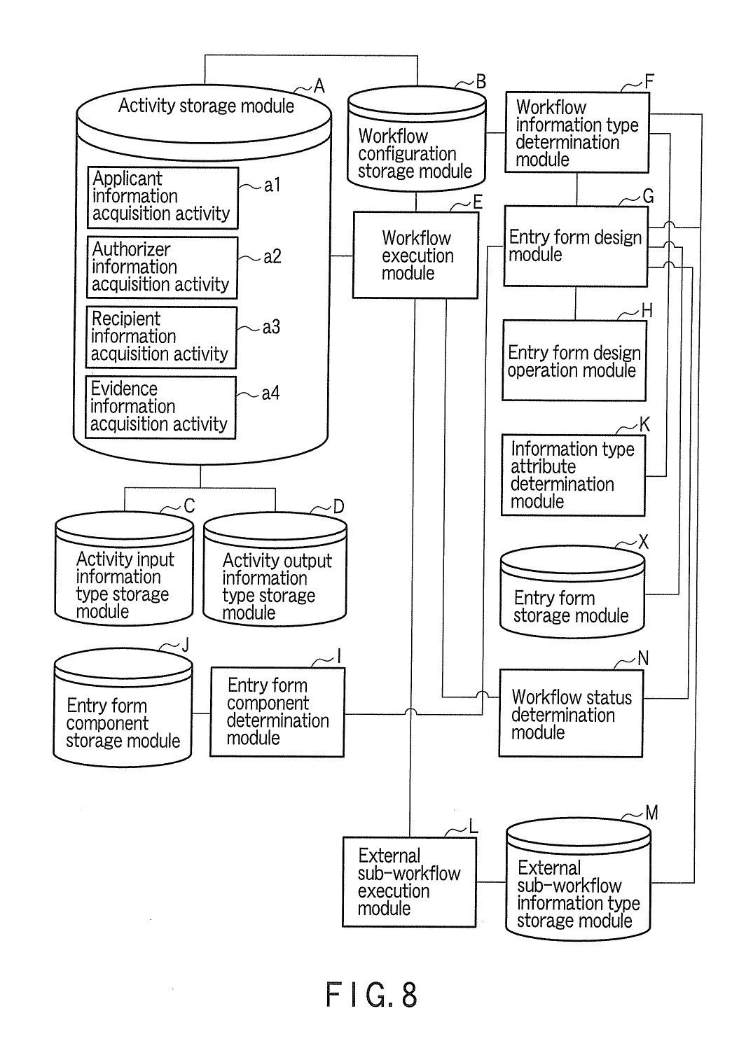

FIG. 8 is a diagram illustrating a configuration example of a workflow system according to a third embodiment.

As illustrated in FIG. 8, the workflow system according to the third embodiment includes an activity storage module A, a workflow configuration storage module B, an activity input information type storage module C, an activity output information type storage module D, a workflow execution module E, a workflow information type determination module F, an entry form design module G, an entry form design operation module H, an entry form component determination module I, an entry form component storage module J, an information type attribute determination module K, and a workflow status determination module (status determination module) N.

The activity storage module A, the workflow configuration storage module B, the activity input information type storage module C, the activity output information type storage module D, the workflow execution module E, the workflow information type determination module F, the entry form design module G, the entry form design operation module H, the entry form component determination module I, the entry form component storage module J, and the information type attribute determination module K have functions as described in the first embodiment.

The workflow status determination module N determines a status of information on the executed workflow. The workflow status determination module N determines a status of information on the workflow if the workflow execution module E executes the workflow. The entry form design module G can design an entry form according to the status of the information determined by the workflow status determination module N.

For example, if a workflow including the authorizer information acquisition activity a2 is executed, the workflow status determination module N determines a status of “authorizer information” output from the authorizer information acquisition activity a2. The workflow status determination module N determines whether or not the authorizer is in a state which allows them to give authorization as the status of the “authorizer information”. Whether or not the authorizer is in the state which allows them to give authorization is determined by authority of the authorizer, location of the authorizer, or the like.

The workflow status determination module N may determine whether or not the authorizer has authority (whether or not in a state which allows them to give authorization) by referring to a server (not shown) that manages the information representing authority of the authorizer (user). The information representing authority of the authorizer is stored in a server that the workflow status determination module N can access to. For example, as the server for storing the information representing authority of the authorizer, a user account management server using Active Directory of Microsoft may be applied.

In addition, the workflow status determination module may determine that the authorizer is not in the state which allows them to give authorization if the authorizer is in absence. Location information of the authorizer may be checked by a schedule management database (not shown), a calendar management database (not shown), or the like. The workflow status determination module N may determine whether or not the authorizer is in absence by referring to a server which manages schedule of the authorizer. For example, as the server which manages schedule of the authorizer, a server having a schedule management function of a SharePoint Server of Microsoft may be applied.

Furthermore, the workflow status determination module N may determine whether or not the authorizer is in the state which allows them to give authorization by combining the authority of the authorizer and the location of the authorizer. That is, the workflow status determination module N may determine that the authorizer is in the state which allows them to give authorization if the authorizer has authority and is not in absence.

If it is determined that the authorizer is not in the state which allows them to give authorization, the workflow status determination module N may determine that a substitute authorizer is needed. That is, in the workflow system according to the third embodiment, if the workflow is executed, there may be provided an operational type of providing an entry form for the substitute to give authorization instead of the “authorizer” if the workflow status determination module N determines the absence of the “authorizer”.

In this operational type, if the workflow status determination module N confirms the absence of the “authorizer”, it notifies the entry form design module G of what the substitute authorizer needs. The entry form design module G designs an entry form including input fields for inputting substitute information depending on the determination result from the workflow status determination module N showing that “authorizer is in absence”. Design of the entry form including the input fields for the substitute information may be performed in the order described according to the first or second embodiment. In addition, the substitute information may include, for example, “substitute name” and “substitute affiliation” as input information similar to the authorizer information.

The entry form according to the status determined by the workflow status determination module N may be designed in advance or whenever the workflow is executed. For example, if the entry form is designed whenever the workflow is executed, the entry form design module G designs an entry form according to a status determine by the workflow status determination module N before the execution of the workflow. Designing of the entry form according to the status may apply, for example, the designing of the entire entry form in the order described according to the first or second embodiment.

In addition, in the designing of the entry form according to the status, the entry form according to the status may be designed by confirming and modifying a template of a model prepared in advance. For example, the entry form design module G adds input fields for substitute information to the template of the model prepared in advance according to the status representing that authorizer information is in absence thereby generating the entry form according to the status.

Furthermore, according to the third embodiment, confirming a status of information used for the workflow during the execution of the workflow is considered. Therefore, the workflow system according to the third embodiment prints the entry form designed according to the status using the digital multi-function peripheral 1 in order to execute the workflow.

The workflow system according to the third embodiment as described above determines the status of the information on the workflow if the workflow is executed and designs an entry form according to the status of each piece of information each time. Accordingly, the workflow system according to the third embodiment may simply provide a suitable entry form according to the status of the executed workflow.

A fourth embodiment will be described.

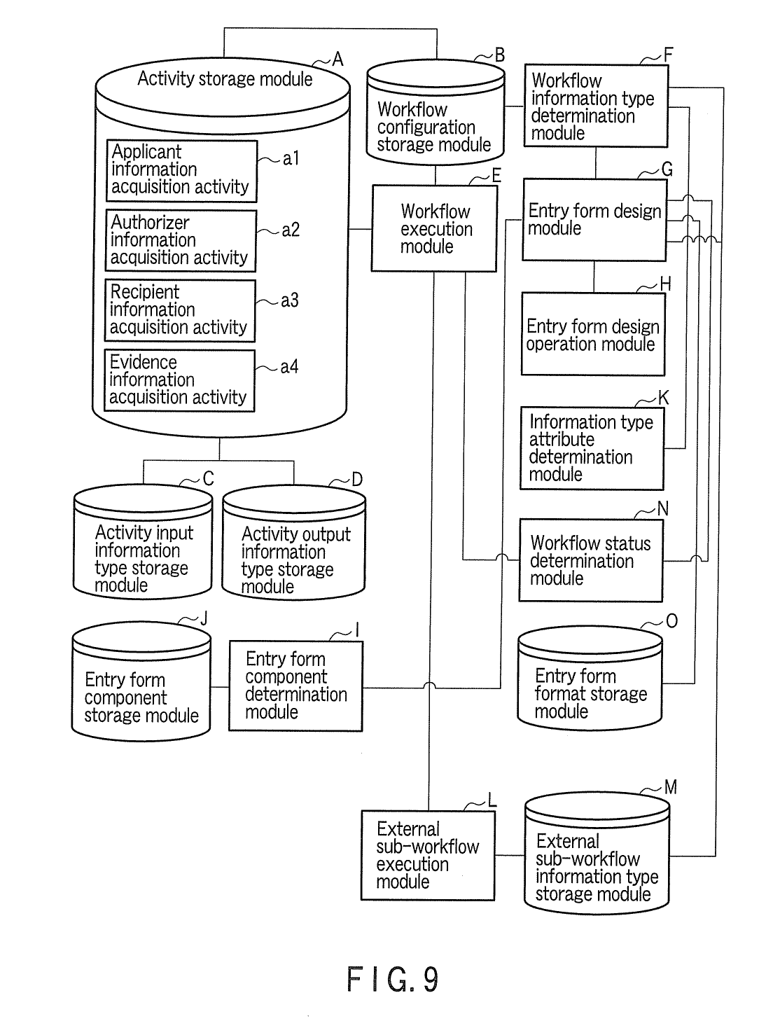

FIG. 9 is a diagram illustrating a configuration example of a workflow system according to a fourth embodiment.

As illustrated in FIG. 9, the workflow system according to the fourth embodiment includes an activity storage module A, a workflow configuration storage module B, an activity input information type storage module C, an activity output information type storage module D, a workflow execution module E, a workflow information type determination module F, an entry form design module G, an entry form design operation module H, an entry form component determination module I, an entry form component storage module J, an information type attribute determination module K, a workflow status determination module N, and an entry form format storage module (form format storage module) O.

The activity storage module A, the workflow configuration storage module B, the activity input information type storage module C, the activity output information type storage module D, the workflow execution module E, the workflow information type determination module F, the entry form design module G, the entry form design operation module H, the entry form component determination module I, the entry form component storage module J, and the information type attribute determination module K have functions as described in the first embodiment. In addition, the workflow status determination module N has the same function as that described in the third embodiment.

The entry form format storage module O stores the entry form designed by the entry form design module G as information on a format according to a method (an output type of the entry form) provided to the user. In the fourth embodiment, as the method of providing the entry form to the user, in addition to a method of printing an entry form onto a sheet, a method of displaying the entry form on a display unit that can be seen by the user may be considered. In addition, as the method of displaying the entry form on the display unit, for example, a method of providing the entry form on a Web browser through a Web server is considered.

If outputting the entry form by printing it onto the sheet is employed, the entry form format storage module O stores the components of the entry form determined by the entry form component determination module I as layout image information in a data format that can be actually printed onto a sheet. If outputting the entry form by providing it on the Web browser or the like through the Web server is employed, the entry form format storage module O stores the components of the entry form determined by the entry form component determination module I and information representing a layout of the components in a data format converted into an HTML code. That is, the entry form format storage module O stores the components of the entry form and information representing the layout of the components in a data format according to the output type of the entry form.

The entry form format storage module O may store the template model of the entry form as described in the third embodiment. That is, the entry form format storage module O may store the template model of the entry form as image data to be actually printed onto the sheet or as data which can be displayed on the display unit to be seen by the user. The data which can be displayed on the display unit is described into, for example, HTML codes to be seen on the browser by the user and transmitted to the Web server.

In the workflow system according to the fourth embodiment as described above, the entry form format storage module O stores design information on the entry form as information on a format according to the method of providing the entry form to the user. Accordingly, the workflow system according to the fourth embodiment can provide the entry form to the user in various providing methods according to the operational type.

A fifth embodiment will now be described.

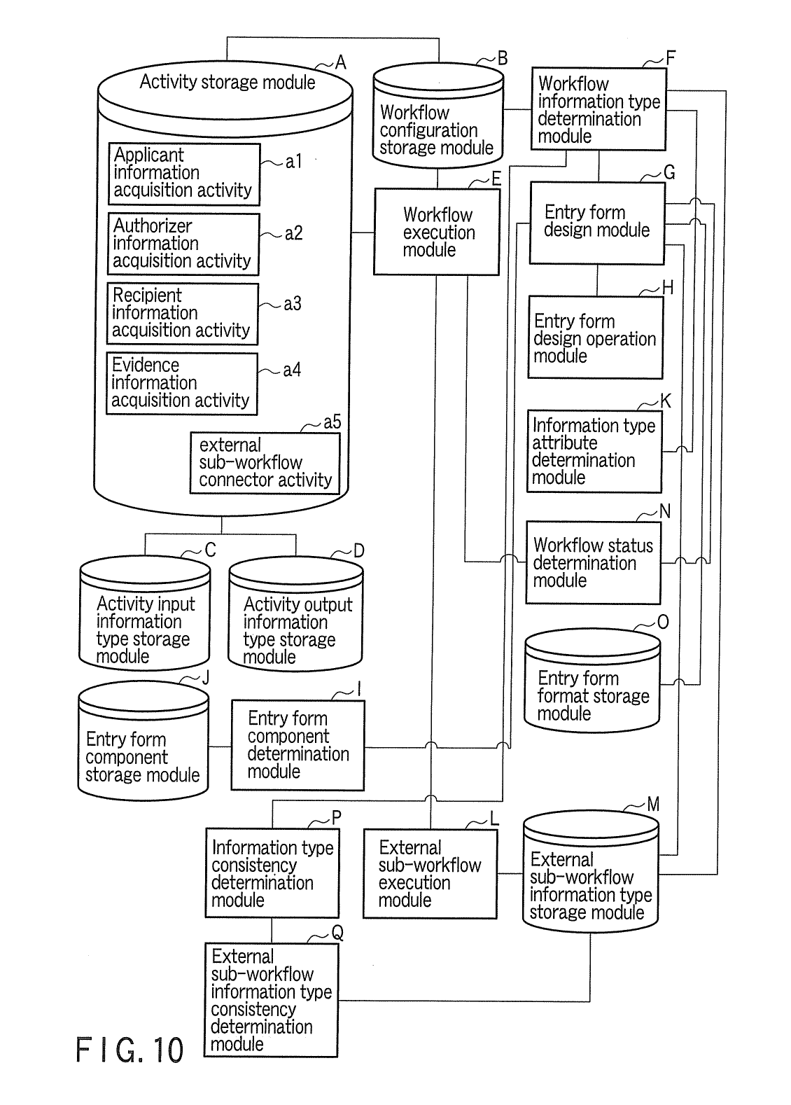

FIG. 10 is a diagram illustrating a configuration example of a workflow system according to a fifth embodiment.

As illustrated in FIG. 10, the workflow system according to the fifth embodiment includes an activity storage module A, a workflow configuration storage module B, an activity input information type storage module C, an activity output information type storage module D, a workflow execution module E, a workflow information type determination module F, an entry form design module G, an entry form design operation module H, an entry form component determination module I, an entry form component storage module J, an information type attribute determination module K, an external sub-workflow execution module L, an external sub-workflow information type determination module M, a workflow status determination module N, an entry form format storage module O, an information type consistency determination module (consistency determination module) P, and an external sub-workflow information type consistency determination module (external consistency determination module) Q.

The activity storage module A, the workflow configuration storage module B, the activity input information type storage module C, the activity output information type storage module D, the workflow execution module E, the workflow information type determination module F, the entry form design module G, the entry form design operation module H, the entry form component determination module I, the entry form component storage module J, and the information type attribute determination module K, the external sub-workflow execution module L, the external sub-workflow information type determination module M, the workflow status determination module N, and the entry form format storage module O may be implemented as the same modules described in the first to fourth embodiments.

The information type consistency determination module P determines the consistency of the information type of input and output information used for the different activities or the external sub-workflow. For example, the information type consistency determination module P determines that the “applicant name” of the applicant information acquisition activity a1 and the “account holder” of the recipient information acquisition activity a3 are the same information. In addition, if the “applicant” and the “authorizer” are users who belong to the same company, the information type consistency determination module P converts the “applicant name” of the applicant information acquisition activity a1 and the “authorizer name” of the authorizer information acquisition activity a2 into an “employee ID number” using a directory service or the like and determines organization information or the like as identifiable information.

The external sub-workflow information type consistency determination module Q determines the consistency of the information types of input and output information used for the external sub-workflow stored in the external sub-workflow information type storage module M.

For example, as the input information needed for the recipient information acquisition activity a3, there is an “account holder”. In the workflow for a travel expense application with evidence attached, the “account holder” is considered to be the same as the “applicant name”. In this case, the information type consistency determination module P determines that the “applicant name” of the applicant information acquisition activity a1 and the “account holder” of the recipient information acquisition activity a3 are the same information. On the basis of the determination result, the information type consistency determination module P determines that it is sufficient that either of the “applicant name” and the “account holder” be entered as the component of the entry form.

The determination result of the consistency between the pieces of input information is notified for the workflow information type determination module F from the information type consistency determination module P. The workflow information type determination module F that receives the information on the consistency between the pieces of input information from the information type consistency determination module P notifies the entry form design module G of the input information needed for the workflow and the information representing the consistency between the pieces of input information.

The entry form design module G that receives the information representing the consistency between the pieces of input information is able to provide the components of the input information from the entry form design operation module H and provide the consistency between the pieces of input information. For example, if it is determined that the “applicant name” and the “account holder” are the same information, the entry form design operation module H may provide that either of the components of the “applicant name” and the “account holder” may be disposed.

In the workflow system according to the fifth embodiment as described above, it is possible to provide the consistency between the pieces of input information by confirming the consistency between the pieces of input information of the plurality of activities constituting the workflow. In addition, in the workflow system according to the fifth embodiment, it is possible to provide the consistency between the pieces of input information by confirming the consistency between the pieces of input information in the external sub-workflow.

A sixth embodiment will now be described.

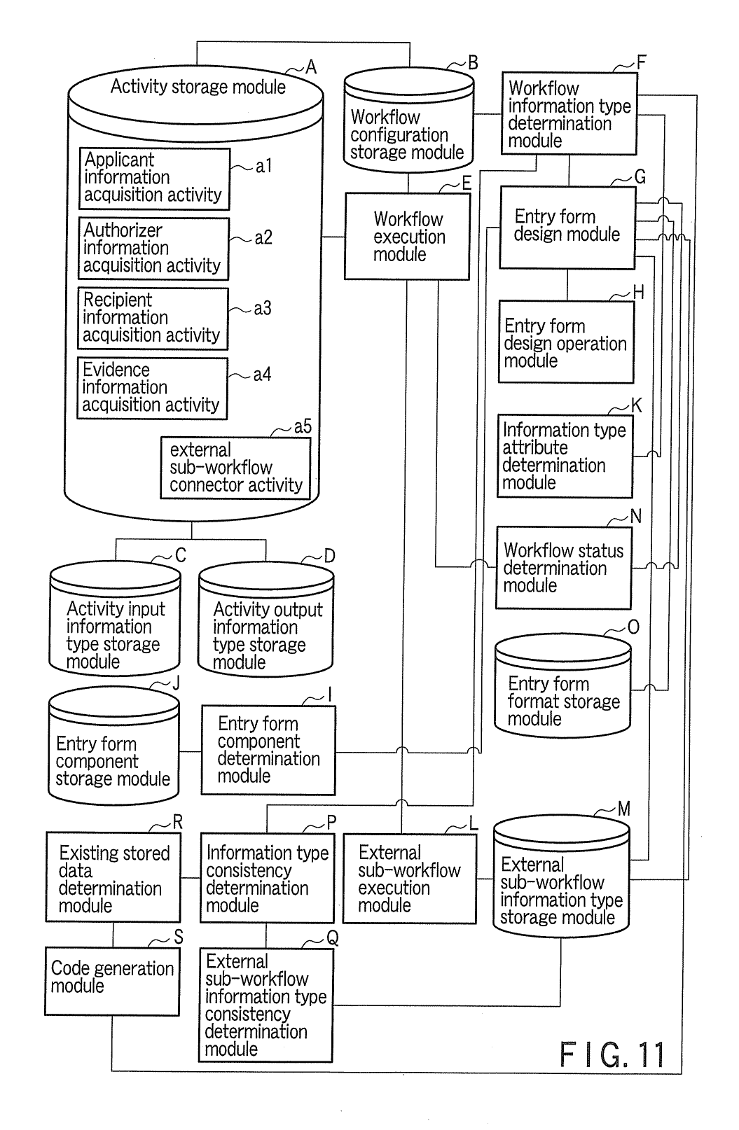

FIG. 11 is a diagram illustrating a configuration example of a workflow system according to a sixth embodiment.

As illustrated in FIG. 11, the workflow system according to the sixth embodiment includes an activity storage module A, a workflow configuration storage module B, an activity input information type storage module C, an activity output information type storage module D, a workflow execution module E, a workflow information type determination module F, an entry form design module G, an entry form design operation module H, an entry form component determination module I, an entry form component storage module J, an information type attribute determination module K, an external sub-workflow execution module L, an external sub-workflow information type determination module M, a workflow status determination module N, an entry form format storage module O, an information type consistency determination module P, an external sub-workflow information type consistency determination module Q, an existing stored data determination module (existing data determination module) R, and a code generation module S.

The activity storage module A, the workflow configuration storage module B, the activity input information type storage module C, the activity output information type storage module D, the workflow execution module E, the workflow information type determination module F, the entry form design module G, the entry form design operation module H, the entry form component determination module I, the entry form component storage module J, and the information type attribute determination module K, the external sub-workflow execution module L, the external sub-workflow information type determination module M, the workflow status determination module N, and the entry form format storage module O may be implemented as the same modules described in the first to fourth embodiments.

The existing stored data determination module R determines whether or not existing data that can be distributed can be used as input information needed for the entry form. The existing data that can be distributed is stored data that the workflow system can access to. For example, as the existing data that can be distributed, data stored in a data server that the workflow system can access to, information stored in a mobile terminal that the workflow system can access to, or the like. For example, the existing stored data determination module R determines that owner information stored the mobile terminal owned by the user can be used as the “applicant name” of the input information of the applicant name acquisition activity a1.

The code generation module S converts data such as text information into code information such as a QR code. The code generation module S may convert existing data determined by the existing stored data determination module R into readable code information. For example, the code generation module S converts the owner information stored in the mobile terminal of the user which is determined to be used as the applicant information of the applicant information acquisition activity a1 by the existing stored data determination module R into code information. The owner information converted into codes by the code generation module S may provided as the component of the entry form by the entry form design operation module H.

For example, in the workflow, in many cases, the name of an applicant is essential input information for an entry form. The applicant information such as the applicant name is originally the same as the owner information stored in the mobile terminal such as a mobile phone owned by the applicant. Therefore, if the owner information stored in the mobile terminal of the applicant is applied, inputting the applicant name to the entry form can be simplified. For example, the code generation module S converts the owner information stored in the mobile terminal into code information and arrange the code information in the entry form as the applicant information, thereby designing the entry form in which inputting the applicant information can be omitted.

That is, the workflow system according to the sixth embodiment has a function of designing an entry form in which inputting information can be simplified by using existing data. For example, the mobile terminal such as a mobile phone can hold the owner information and transmit the data using a communication unit. The existing stored data determination module R determines a correspondence between the owner information transmitted from the mobile terminal and the input information in the workflow.

If it is determined that the applicant information (the applicant name and the applicant affiliation) is included in the owner information received from the mobile terminal as the input information of the workflow, the code generation module S converts the owner information received from the mobile terminal into code information such as a QR code. Since the “applicant name” and the “applicant affiliation” are included in the owner information, instead of arranging the input fields of the “applicant name” and the “applicant affiliation” in the entry form, the code generation module S may give the generated code information on the owner information to the entry form. In this entry form, the user does not need effort to input the “applicant name” and the “applicant affiliation”.

In addition, the code generation module S may computerize information representing an access point such as URL about image information stored in the data server that the workflow system can access to, into codes. For example, receipt image as evidence is stored in the data server (not shown) that the workflow system can access to. The code generation module S converts the information (for example, URL information) representing an access point of a receipt image as evidence stored in the data server into code information. The information representing the access point converted into the code information may be assigned to the entry form instead of disposing an attachment field for the receipt image of the evidence information acquisition activity a4. In the entry form, the user does not need effort to attach the receipt to the attachment field.

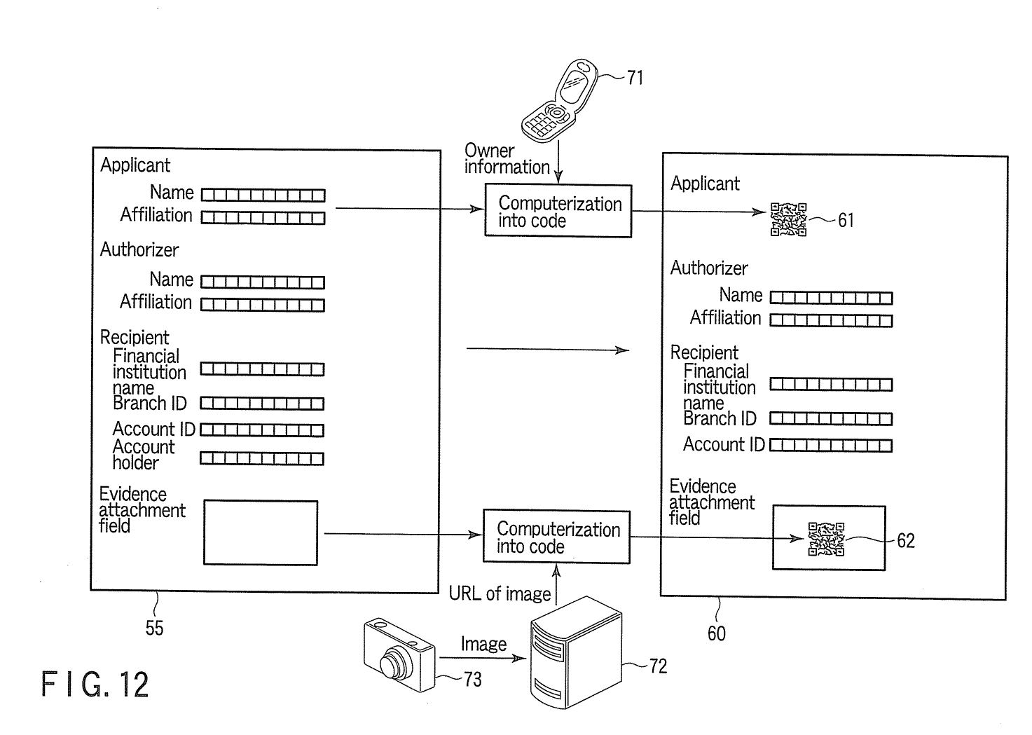

FIG. 12 is a diagram illustrating an example of an entry form assigned with code information generated by the code generating module S. In FIG. 12, an example of the entry form 55 illustrated in FIG. 4 and an example of the entry form 60 generated by coding a part of the entry form 55 are illustrated.

In the entry form 60 illustrated in FIG. 12, code information 61 is assigned to in an applicant field, and code information 62 is assigned to an evidence attachment field. The code information 61 is information obtained by coding the owner information acquired from the mobile terminal 71 owned by the user. The code information 62 is information obtained by coding URL information to access to the image information stored in the data server 72.

That is, if the existing stored data determination module R determines that the owner information stored in the mobile terminal 71 owned by the user can be used as the applicant information of the entry form, the code generation module S converts the owner information acquired from the mobile terminal 71 owned by the user into the code information 61 as a two-dimensional barcode.

In addition, if the existing stored data determination module R determines that the image information stored in the data server 72 can be used as receipt information (evidence information) for the entry form, the code generation module S converts the URL information on the image information stored in the data server 72 into the code information 62 as the two-dimensional barcode. The data server 72 can store receipt image taken by the user using such as a digital camera 73, so that the receipt image can be referred to as URL.

The workflow system according to the sixth embodiment as described above, can determine whether or not the existing data (data stored in the mobile terminal or data stored in the server) can be used as the input information for the entry form, and give the usable existing data or information to access to the existing data to the entry form. In addition, the workflow system according to the sixth embodiment as described above can converts the existing data or the information to access to the existing data into code information to give the code information to the entry form. In the workflow system according to the sixth embodiment, it is possible to design the entry form with reduced input items by using the existing data.

In the disclosed embodiments, the processing can be accomplished by a computer-executable program, and this program can be realized in a computer-readable memory device. In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A workflow system comprising:
an activity storage module configured to store activities which are process constitution units of a workflow;
an input type storage module storing types of input information which are input to the activities stored in the activity storage module;
an output type storage module configured to store types of output information which are output from the activities stored in the activity storage module;
an information determination module configured to determine input information needed for the workflow constituted by a plurality of the activities depending on the types of the input information and the output information of the activities stored in the input type storage module and the output type storage module;
a form creation module configured to create an input form for inputting the input information determined by the information determination module; and
a form design operation module configured to provide an environment for designing the input form created by the form creation module.

2. The system according to claim 1, further comprising:
a component storage module configured to store component candidates for inputting various types of the input information; and
a component determination module configured to determine components candidates for inputting the input information of the workflow determined by the information determination module from the component storage module,
wherein the form creation module creates the input form in which the component candidates determined by the component determination module are arranged.

3. The system according to claim 1, further comprising: an attribute determination module configured to determine attributes of the input information determined by the information determination module,
wherein the form creation module creates the input form representing the attribute of the input information determined by the information determination module.

4. The system according to claim 1, further comprising: an external type storage module configured to store information used by an external sub-workflow executed by an external system,
wherein the information determination module determines input information needed for the external sub-workflow on the basis of the information stored in the external type storage module.

5. The system according to claim 1, further comprising: a status determination module configured to determine a status of information on the workflow,
wherein the form creation module creates the input form for inputting the input information according to the status determined by the status determination module.

6. The system according to claim 1, further comprising: a form format storage module configured to store the input form created by the form creation module as information on a format according to a provided method.

7. The system according to claim 1, further comprising: a consistency determination module configured to determine consistency of the information types between the input information of the activities constituting the workflow,
wherein the form design operation module provides information representing the consistency between the input information determined by the consistency determination module.

8. The system according to claim 1, further comprising: an existing data determination module configured to determine whether or not existing data can be used as the input information needed for the input form,
wherein the form creation module creates the input form in which the existing data determined to be used by the existing data determination module is arranged.

9. A method of creating an entry form used for a workflow, the method comprising:
storing types of input information which are input to activities that are process constitution units of the workflow, and types of output information which are output from the activities;
determining input information needed for the workflow constituted by a plurality of the activities depending on the types of the input information and the output information of the stored activities;
providing a design environment for designing an input form for inputting the input information determined to be needed for the workflow; and
creating the input form designed in the design environment.

10. The method according to claim 9, further comprising:
storing component candidates for inputting various types of the input information; and
determining components candidates for inputting the determined input information of the workflow from the stored component candidates,
wherein in the creating of the input form, the input form is created in which the determined component candidates are arranged.

11. The method according to claim 9, further comprising: determining an attribute of the determined input information of the workflow,
wherein in the creating of the input form, the input form is created for representing the determined attribute of the input information.

12. The method according to claim 9, further comprising:
storing information used by an external sub-workflow executed by an external system; and
determining the input information needed for the external sub-workflow on the basis of the stored information.

13. The method according to claim 9, further comprising: determining a status of information on the workflow,
wherein in the creating of the input form, the input form is created for inputting the input information according to the determined status.

14. The method according to claim 9, further comprising: storing the created input form as information on a format according to a provided method.

15. The method according to claim 9, further comprising:
determining consistency of the information types between the input information of the activities constituting the workflow; and
providing information representing the determined consistency between the input information in a design environment for designing the input form.

16. The method according to claim 9, further comprising: determining whether or not existing data is used as the input information needed for the input form,
wherein in the creating of the input form, the input form is created in which the existing data that is determined to be used as the input information is arranged.

17. A computer-readable memory containing program instructions by a processor for:
an activity storage function to store activities which are process constitution units of a workflow;
an input type storage function to store types of input information which are input to the activities stored by the activity storage function;
an output type storage function to store types of output information which are output from the activities stored by the activity storage function;
an information determination function to determine input information needed for the workflow constituted by a plurality of the activities depending on the types of the input information and the output information of the activities stored by the input type storage function and the output type storage function;
a form creation function to create an input form for inputting the input information determined by the information determination function; and
a form design operation function to provide an environment for designing the input form created by the form creation function.

18. The computer-readable memory according to claim 17, further comprising:
a component storage function to store component candidates for inputting various types of the input information; and
a component determination function to determine components candidates for inputting the input information of the workflow determined by the information determination function from the component storage function,
wherein the form creation function creates the input form in which the component candidates determined by the component determination function are arranged.
